(19) United States
(12) Patent Application Publication
(10) Pub. No.: US 2026/0149140 A1
(43) Pub. Date: May 28, 2026

(54) TERMINAL AND BATTERY WIRING MODULE

(71) Applicant: SUMITOMO WIRING SYSTEMS, LTD., Mie (JP)

(72) Inventor: Yuto OKANO, Mie (JP)

(21) Appl. No.: 19/400,182

(22) Filed: Nov. 25, 2025

(30) Foreign Application Priority Data
Nov. 27, 2024 (JP) 2024-206366

(51) Int. Cl. H01M 50/557; H01M 50/562

(52) U.S. Cl. CPC H01M 50/557; H01M 50/562

(57) ABSTRACT

A terminal includes: a resin molded portion; a plate-shaped conductive member which is partially embedded in the resin molded portion; and an electronic component that is connected to the conductive member. An upper surface of the conductive member includes: a first surface that is in contact with the resin molded portion; a stepped surface that extends downward from the first surface; and a second surface that is connected to the first surface via the stepped surface and located at a position lower than the first surface. The second surface is entirely located outside of the resin molded portion. The electronic component is connected to the second surface.

### CROSS-REFERENCE TO RELATED APPLICATIONS

This application is based on and claims priority from Japanese Patent Application No. 2024-206366, filed on Nov. 27, 2024, with the Japan Patent Office, the disclosure of which is incorporated herein in its entirety by reference.

### TECHNICAL FIELD

The present disclosure relates to a terminal and a battery wiring module.

### BACKGROUND

Conventionally, a terminal in which an electronic component such as a chip fuse or a diode is mounted has been proposed (see, for example, JP 2002-042979 A). The terminal includes a resin molded portion, a plate-shaped conductive member which is partially embedded in the resin molded portion, and an electronic component that is connected to the conductive member. The conductive member includes an embedded portion that is embedded in the resin molded portion and a protruding portion that protrudes from the resin molded portion. The electronic component is connected to the protruding portion of the conductive member.

### SUMMARY

In the terminal described above, if burrs generated from the resin molded portion are formed on a surface of the protruding portion of the conductive member, the burrs may cause a connection failure between the conductive member and the electronic component.

It is an object of the present disclosure to provide a terminal and a battery wiring module that enable an improvement in connection reliability between a conductive member and an electronic component.

A terminal according to the present disclosure is a terminal including: a resin molded portion; a plate-shaped conductive member which is partially embedded in the resin molded portion; and an electronic component that is connected to the conductive member, wherein an upper surface of the conductive member includes: a first surface that is in contact with the resin molded portion; a stepped surface that extends downward from the first surface; and a second surface that is connected to the first surface via the stepped surface and located at a position lower than the first surface, the second surface is entirely located outside of the resin molded portion, and the electronic component is connected to the second surface.

With the terminal and the battery wiring module according to the present disclosure, it is possible to improve the connection reliability between a conductive member and an electronic component.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic configuration diagram of a battery wiring module according to one embodiment.

FIG. 2 is a perspective view of a terminal according to the embodiment.

FIG. 3 is a cross-sectional view of the terminal according to the embodiment.

FIG. 4 is a partial cross-sectional view showing a surrounding structure of a resin molded portion of the terminal according to the embodiment.

FIG. 5 is a cross-sectional view showing a molding structure of the resin molded portion of the terminal according to the embodiment.

FIG. 6 is a partial cross-sectional view showing a surrounding structure of a resin molded portion of a terminal according to a variation.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiment of the Present Disclosure

First, aspects of an embodiment according to the present disclosure will be listed and described.
[1] A terminal according to the present disclosure is a terminal including: a resin

molded portion; a plate-shaped conductive member which is partially embedded in the resin molded portion; and an electronic component that is connected to the conductive member, wherein an upper surface of the conductive member includes: a first surface that is in contact with the resin molded portion; a stepped surface that extends downward from the first surface; and a second surface that is connected to the first surface via the stepped surface and located at a position lower than the first surface, the second surface is entirely located outside of the resin molded portion, and the electronic component is connected to the second surface.

With this configuration, the second surface of the conductive member that is connected to the electronic component is entirely located outside of the resin molded portion. Also, in the upper surface of the conductive member, the stepped surface is provided between the second surface and the first surface that is in contact with the resin molded portion. With this configuration, due to the stepped surface, burrs of the resin molded portion in a portion that is in contact with the first surface are unlikely to reach the second surface, and it is therefore possible to make it unlikely for the burrs to be formed on the second surface. Accordingly, the connection reliability between the conductive member and the electronic component can be improved.
[2] In the terminal according to clause [1], the resin molded portion may include a positioning surface configured to allow the electronic component to be positioned. The conductive member may include: an embedded portion that includes the first surface as an upper surface thereof and is embedded in the resin molded portion; and a first protruding portion that includes the second surface as an upper surface thereof and protrudes outside of the resin molded portion from the positioning surface.

With this configuration, by positioning the electronic component using the positioning surface of the resin molded portion when the electronic component is connected to the conductive member, misalignment of the electronic component can be prevented.
[3] In the terminal according to clause [2], the positioning surface may be formed above the stepped surface.

With this configuration, due to the stepped surface, the burrs that extend from the positioning surface are unlikely to reach the second surface, and it is therefore possible to make it unlikely for the burrs to be formed on the second surface. Accordingly, the connection reliability between the conductive member and the electronic component can be improved.
[4] In the terminal according to clause [2] or [3], the conductive member may

further include a second protruding portion that protrudes outward from the resin molded portion, and the second protruding portion includes: a crimped portion to which an electric wire is crimped; and a bent portion that is provided between a root portion of the second protruding portion and the crimped portion.

With this configuration, a stress applied onto the crimped portion when the electric wire is crimped is absorbed by the bent portion. Accordingly, it is possible to minimize the crimping stress that is transmitted to the first protruding portion that is connected to the electronic component.
[5] In the terminal according to any one of clauses [1] to [4], the terminal may

include two conductive members, each of which is configured as defined in clause [1], and the two conductive members may be electrically connected to each other via the electronic component.

With this configuration, the two conductive members are electrically connected to each other via the electronic component, and thus due to the stepped surfaces of the two conductive members, the connection reliability between each of the conductive members and the electronic component can be improved.
[6] In the terminal according to clause [5], the resin molded portion may include: a bottom wall that covers an underside of the two conductive members; and a surrounding wall that extends upward from the bottom wall and surrounds the electronic component, the bottom wall may include a recess portion that is recessed downward at a position between the second surfaces of the two conductive members, and the electronic component may be connected to the second surfaces of the two conductive members through soldering.

With this configuration, it is possible to cause the solder that has overflowed from between the electronic component and the second surfaces of the two conductive members to flow into the recess portion that is formed in the bottom wall of the resin molded portion. Accordingly, it is possible to prevent a solder bridge from being formed between the second surfaces of the two conductive members.
[7] A battery wiring module according to the present disclosure includes the terminal according to any one of clauses [1] to [6].

With this configuration, in the conductive member of the terminal, the second surface that is connected to the electronic component is entirely located outside of the resin molded portion. Also, in the upper surface of the conductive member, the stepped surface is provided between the second surface and the first surface that is in contact with the resin molded portion. With this configuration, due to the stepped surface, burrs of the resin molded portion in a portion that is in contact with the first surface are unlikely to reach the second surface, and it is therefore possible to make it unlikely for the burrs to be formed on the second surface. Accordingly, the connection reliability between the conductive member and the electronic component can be improved.

### Detailed Description of Embodiment of the Present Disclosure

Specific examples of a terminal and a battery wiring module according to the present disclosure will be described below with reference to the drawings. In the drawings, for the sake of ease of description, some constituent elements may be shown in an exaggerated or simplified manner. Also, the dimensional ratio of constituent elements may vary from drawing to drawing. The term “perpendicular” used in the specification of the present application encompasses not only the case where things are strictly perpendicular, but also the case where things are substantially perpendicular within the range where the operation and advantageous effects of an embodiment of the present disclosure can be achieved. Also, the terms such as “first” and “second” in the specification of the present application are used to simply distinguish constituent elements from each other, and thus are not intended to mean the order of constituent elements. The present invention is not limited to the examples given herein, the scope of the invention of the present application is indicated by the appended claims, and all changes that come within the meaning and range of equivalency of the claims are intended to be embraced within the scope of the invention of the present application.

### Configuration of Battery Wiring Module 10

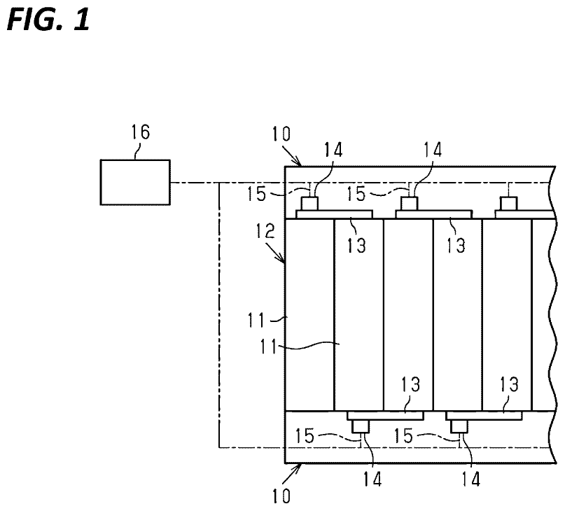

As shown in FIG. 1, a battery wiring module 10 according to the present embodiment is used in, for example, a battery mounted on an electric car, a hybrid car, or the like. The battery wiring module 10 is provided on each side of a battery stack 12 in a width direction of the battery stack 12 in which a plurality of battery cells 11 are arranged in parallel. The battery wiring module 10 includes: a plurality of bus bars 13 that connect adjacent battery cells 11; a plurality of terminals 14 each of which is connected to the plurality of bus bars 13; and an electric wire 15 that is connected to each of the plurality of terminals 14. The electric wire 15 is, for example, a voltage detection electric wires for detecting the voltage of the battery cells 11. The electric wire 15 is connected to a connector 16 that is connected to a voltage detection device (not shown).

### Configuration of Terminal 14

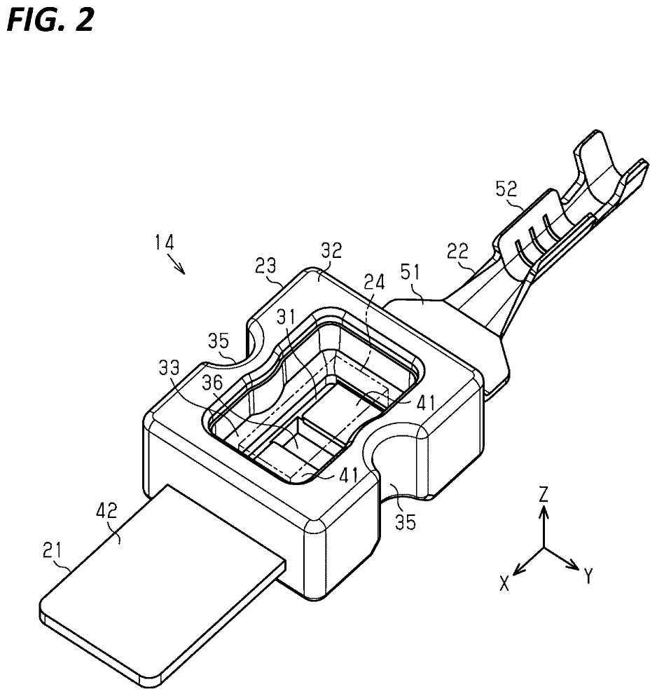

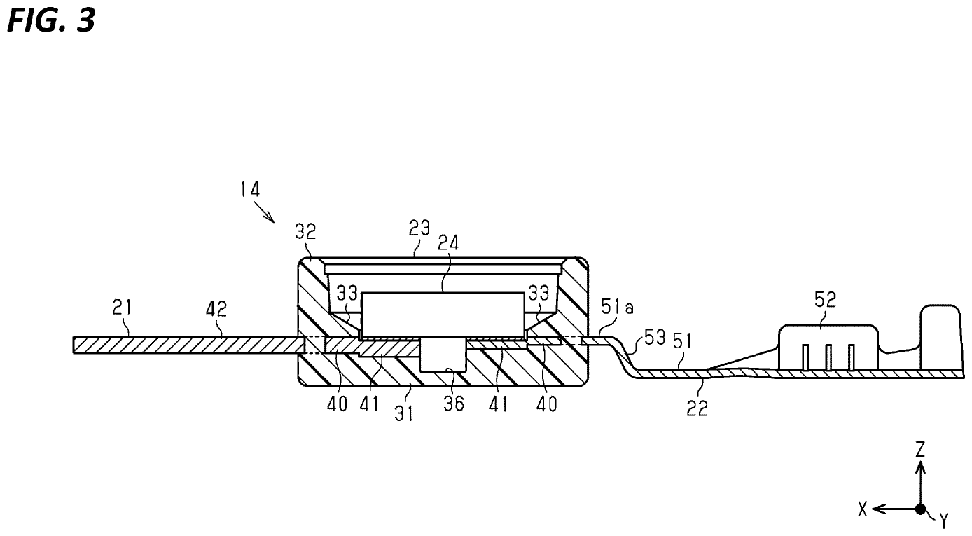

As shown in FIGS. 2 and 3, a terminal 14 according to the present embodiment includes a first conductive member 21, a second conductive member 22, a resin molded portion 23 made of a resin, and an electronic component 24.

The first conductive member 21 and the second conductive member 22 each have a plate shape. The first conductive member 21 and the second conductive member 22 are each formed from, for example, a metal plate through press processing. The first conductive member 21 and the second conductive member 22 are electrically connected to each other via the electronic component 24. As the electronic component 24, for example, a chip fuse, a diode, or the like is used. The resin molded portion 23 is configured to cover a portion of the first conductive member 21, a portion of the second conductive member 22, and the electronic component 24. The resin molded portion 23 is formed by insert molding using the first conductive member 21 and the second conductive member 22 as inserts.

In the drawings, a lengthwise direction X, a width direction Y, and a height direction Z that are three mutually perpendicular directions are shown. In the description given below, the terms “upper” and “lower” in the height direction Z may also be referred to simply as “upper” and “lower”. It should be noted that the terminal 14 is not necessarily provided in such an orientation that an upper portion of the terminal 14 in the height direction Z faces upward.

### Configuration of Resin Molded Portion 23

The resin molded portion 23 includes: a bottom wall 31 that covers an underside of the conductive members 21 and 22; and a surrounding wall 32 that extends upward from the bottom wall 31. The electronic component 24 is provided on an inner circumferential side of the surrounding wall 32. That is, the surrounding wall 32 is configured to surround the electronic component 24. The inside of the inner circumferential side of the surrounding wall 32 is filled with a potting material (not shown) in a state in which the electronic component 24 is connected to the conductive members 21 and 22.

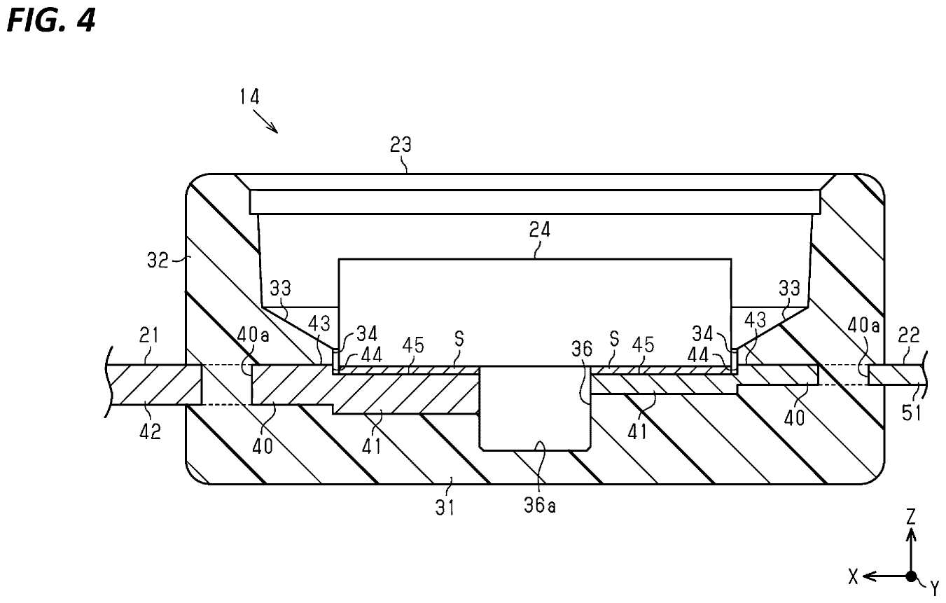

As shown in FIG. 4, an inner circumferential surface of the surrounding wall 32 includes a tapered surface 33 and a pair of positioning surfaces 34. The tapered surface 33 is inclined toward the inner circumferential side such that the electronic component 24 can be guided to an appropriate position during assembly of the electronic component 24. The pair of positioning surfaces 34 are provided at a lower end of the tapered surface 33. The pair of positioning surfaces 34 are provided on opposite sides of the electronic component 24 in the lengthwise direction X to sandwich the electronic component 24 in the lengthwise direction X. Each positioning surface 34 is a surface that is perpendicular to or intersects the lengthwise direction X. The electronic component 24 is positioned in the lengthwise direction X by the pair of positioning surfaces 34.

As shown in FIG. 2, positioning recess portions 35 that extend along the height direction Z are formed in an outer circumferential surface of the resin molded portion 23. The positioning recess portions 35 are respectively provided on, for example, opposite side surfaces of the resin molded portion 23 in the width direction Y. For example, when the electronic component 24 is connected to the conductive members 21 and 22, positioning pins (not shown) are fitted into the positioning recess portions 35, and the resin molded portion 23 is thereby positioned.

### Configuration of First Conductive Member 21

As shown in FIG. 4, the first conductive member 21 includes: an embedded portion 40 that is embedded in the resin molded portion 23; and a first protruding portion 41 and a second protruding portion 42 that each protrude from the resin molded portion 23.

The embedded portion 40 extends through the surrounding wall 32 of the resin molded portion 23. The embedded portion 40 includes a through hole 40a that extends through the embedded portion 40 in a thickness direction (the height direction Z). The through hole 40a is filled with a resin that constitutes the resin molded portion 23. With this configuration, the first conductive member 21 is prevented from escaping from the resin molded portion 23.

The first protruding portion 41 is connected to the embedded portion 40 and protrudes from the positioning surface 34 toward the inner circumferential side of the surrounding wall 32. The first protruding portion 41 is formed to be placed at a position lower than the embedded portion 40 through, for example, half-blanking processing.

An upper surface of the first conductive member 21 includes: a first surface 43 that is in contact with the resin molded portion 23; a stepped surface 44 that extends downward from the first surface 43; and a second surface 45 that is connected to the first surface 43 via the stepped surface 44 and located at a position lower than the first surface 43. The first surface 43 is an upper surface of the first protruding portion 41. The stepped surface 44 is formed by deforming the first protruding portion 41 through the above-described half-blanking processing. The second surface 45 is an upper surface of the embedded portion 40. The first surface 43 is entirely located outside of the resin molded portion 23, specifically, located on the inner circumferential side of the surrounding wall 32. The electronic component 24 is connected to first surface 43.

The positioning surface 34 of the resin molded portion 23 is formed above the stepped surface 44. In the present embodiment, the positioning surface 34 and the stepped surface 44 are formed to be continuous in an up-down direction and flush with each other.

The second protruding portion 42 of the first conductive member 21 is connected to the embedded portion 40, and protrudes from the resin molded portion 23 toward an outer circumferential side of the surrounding wall 32. The second protruding portion 42 is connected to one of the bus bars 13 described above. The second protruding portion 42 and the bus bar 13 are connected to each other through, for example, laser welding.

### Configuration of Second Conductive Member 22

Hereinafter, the second conductive member 22 will be described. In the description given below, constituent elements of the second conductive member 22, that are the same as those of the first conductive member 21 are given the same reference numerals of the constituent elements of the first conductive member 21, and a detailed description thereof will be omitted.

As shown in FIGS. 2 and 3, the second conductive member 22 includes: an embedded portion 40 that is embedded in the resin molded portion 23; and a first protruding portion 41 and a second protruding portion 51 that each protrude from the resin molded portion 23. Also, as shown in FIG. 4, the second conductive member 22 includes a first surface 43, a stepped surface 44, and a second surface 45 that are the same as those of the first conductive member 21. The first conductive member 21 and the second conductive member 22 are electrically connected to each other via the electronic component 24 by the electronic component 24 being connected, using solder S, to the first surface 43 of the first protruding portion 41 of the conductive member 21 and the first surface 43 of the first protruding portion 41 of the conductive member 22.

### Configuration of Recess Portion 36 of Resin Molded Portion 23

The bottom wall 31 of the resin molded portion 23 includes a recess portion 36 that is recessed downward at a position between the first surface 43 of the conductive member 21 and the first surface 43 of the conductive member 22. The recess portion 36 is, for example, a recess portion that does not extend through the bottom wall 31, and includes a bottom surface 36a. The bottom surface 36a is located at a position lower than a lower surface of the first protruding portion 41 of the conductive member 21 and a lower surface of the first protruding portion 41 of the conductive member 22. The recess portion 36 is configured to cause, if the solder S that connects the electronic component 24 and the first surface 43 of the first protruding portion 41 overflows from between the electronic component 24 and the first surface 43, the overflowed solder S to flow into the recess portion 36.

### Configuration of Second Protruding Portion 51 of Second Conductive Member 22

As shown in FIG. 3, the second protruding portion 51 of the second conductive member 22 is connected to the embedded portion 40, and protrudes from the resin molded portion 23 toward the outer circumferential side of the surrounding wall 32. The second protruding portion 51 includes: a crimped portion 52 to which the electric wire 15 described above is crimped; and a bent portion 53 that is provided between a root portion 51a of the second protruding portion 51 and the crimped portion 52. The root portion 51a of the second protruding portion 51 is a basal end portion of the second protruding portion 51 that protrudes from the resin molded portion 23, and is a portion of the second protruding portion 51 that is located near the resin molded portion 23. The bent portion 53 is bent in the thickness direction from the root portion 51a toward the crimped portion 52. The bent portion 53 of the present embodiment is bent, for example, obliquely downward from the root portion 51a toward the crimped portion 52.

### Operation of the Present Embodiment

Hereinafter, an operation of the present embodiment will be described.

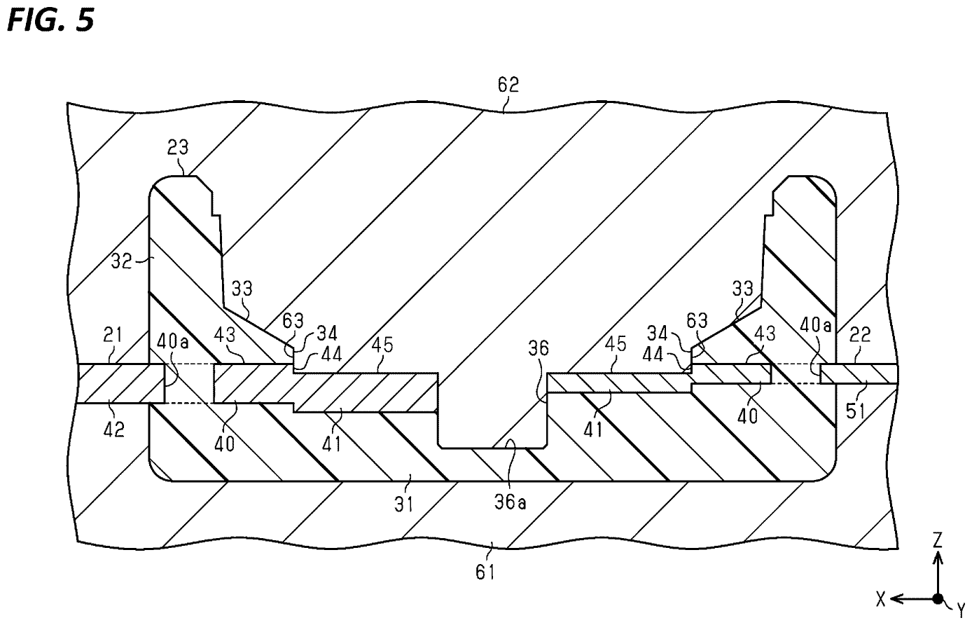

As shown in FIG. 5, a resin molded portion 23 is injection molded using a first mold 61 and a second mold 62. First, conductive members 21 and 22 are placed in the first mold 61. After that, the second mold 62 is placed aligned on the first mold 61 from above. A cavity is thereby formed between the first mold 61 and the second mold 62. Then, the cavity between the first mold 61 and the second mold 62 is filled with a resin. In this way, the resin molded portion 23 is formed.

The second mold 62 includes a pair of molding surfaces 63 for molding a pair of positioning surfaces 34 in the resin molded portion 23. Each molding surface 63 is a surface that is perpendicular to or intersects the lengthwise direction X. During molding of the resin molded portion 23, the molding surfaces 63 are respectively abutted against the stepped surface 44 of the conductive member 21 and the stepped surface 44 of the conductive member 22 in the lengthwise direction X. With this configuration, each positioning surface 34 is formed to be arranged continuously with the corresponding stepped surface 44 in the up-down direction along the molding surface 63. With the configuration described above in which the stepped surface 44 is provided between the positioning surface 34 and the first surface 43, it is possible to prevent burrs that may be formed on the positioning surface 34 from being formed to reach the first surface 43 where an electronic component 24 is connected. Also, with the configuration in which the stepped surface 44 is provided between the positioning surface 34 and the first surface 43, the stepped surface 44 prevents a gas generated during resin molding from reaching the first surface 43. As a result, it is possible to prevent an insulating film from being formed on the first surface 43 by the gas.

After the resin molded portion 23 has been molded, an electronic component 24 is connected to the first surface 43 of the conductive member 21 and the first surface 43 of the conductive member 22 through soldering. As described above, with the stepped surface 44, the generation of burrs and an insulating film on the first surface 43 is prevented, and thus the occurrence of a connection failure between the electronic component 24 and the first surface 43 is prevented.

### Advantageous Effects of the Present Embodiment

Hereinafter, the advantageous effects of the present embodiment will be described.
(1) The terminal 14 includes: the resin molded portion 23; the plate-shaped conductive member 21 or 22, that is partially embedded in the resin molded portion 23; and the electronic component 24 that is connected to the conductive member 21 or 22. The upper surface of the conductive member 21 or 22 includes: the first surface 43 that is in contact with the resin molded portion 23; the stepped surface 44 that extends downward from the first surface 43; and the second surface 45 that is connected to the first surface 43 via the stepped surface 44 and located at a position lower than the first surface 43. The second surface 45 is entirely located outside of the resin molded portion 23. The electronic component 24 is connected to the second surface 45. With this configuration, the second surface 45 of the conductive member 21 or 22 that is connected to the electronic component 24 is entirely located outside of the resin molded portion 23. Also, in the upper surface of the conductive member 21 or 22, the stepped surface 44 is provided between the second surface 45 and the first surface 43 that is in contact with the resin molded portion 23. With this configuration, due to the stepped surface 44, burrs of the resin molded portion 23 in a portion that is in contact with the first surface 43 are unlikely to reach the second surface 45, and it is therefore possible to make it unlikely for the burrs to be formed on the second surface 45. Accordingly, the connection reliability between the conductive member 21 or 22 and the electronic component 24 can be improved.
(2) The resin molded portion 23 includes the positioning surface 34 configured to allow the electronic component 24 to be positioned. The conductive member 21 or 22 includes: the embedded portion 40 that includes the first surface 43 as an upper surface thereof and is embedded in the resin molded portion 23; and the first protruding portion 41 that includes the second surface 45 as an upper surface thereof and protrudes outside of the resin molded portion 23 from the positioning surfaces 34. With this configuration, by positioning the electronic component 24 using the positioning surface 34 of the resin molded portion 23 when the electronic component 24 is connected to the conductive member 21 or 22, misalignment of the electronic component 24 can be prevented. Also, the placement position of the electronic component 24 is clearly specified by the positioning surface 34, and thus the assembly workability of the electronic component 24 is improved.
(3) The positioning surface 34 is formed above the stepped surface 44. With this configuration, due to the stepped surface 44, the burrs that extend from the positioning surface 34 are unlikely to reach the second surface 45, and it is therefore possible to make it unlikely for the burrs to be formed on the second surface 45. Accordingly, the connection reliability between the conductive member 21 or 22 and the electronic component 24 can be improved.
(4) The second conductive member 22 includes the second protruding portion 51 that protrudes outward from the resin molded portion 23. The second protruding portion 51 includes: the crimped portion 52 to which the electric wire 15 is crimped; and the bent portion 53 that is provided between the root portion 51a of the second protruding portion 51 and the crimped portion 52. With this configuration, a stress applied onto the crimped portion 52 when the electric wire 15 is crimped is absorbed by the bent portion 53. Accordingly, it is possible to minimize the crimping stress that is transmitted to the first protruding portion 41 that is connected to the electronic component 24.
(5) The terminal 14 includes two conductive members (the first conductive member 21 and the second conductive member 22). The first conductive member 21 and the second conductive member 22 are electrically connected to each other via the electronic component 24. With this configuration, the first conductive member 21 and the second conductive member 22 are electrically connected to each other via the electronic component 24, and thus due to the stepped surface 44 of the conductive member 21 and the stepped surface 44 of the conductive member 22, the connection reliability between each of the conductive members 21 and 22 and the electronic component 24 can be improved.
(6) The resin molded portion 23 includes: the bottom wall 31 that covers the underside of the first conductive member 21 and the underside of the second conductive member 22; and the surrounding wall 32 that extends upward from the bottom wall 31 and surrounds the electronic component 24. The bottom wall 31 includes the recess portion 36 that is recessed downward at a position between the second surface 45 of the conductive member 21 and the second surface 45 of the conductive member 22. The electronic component 24 is connected to the second surfaces 45 of the conductive members 21 and 22 through soldering. With this configuration, it is possible to cause the solder S that has overflowed from between the electronic component 24 and the second surfaces 45 of the conductive members 21 and 22 to flow into the recess portion 36 that is formed in the bottom wall 31 of the resin molded portion 23. Accordingly, it is possible to prevent a solder bridge from being formed between the second surfaces 45 of the two conductive members 21 and 22, and also prevent the conductive members 21 and 22 from being electrically connected to each other via the solder bridge.

### Other Embodiments

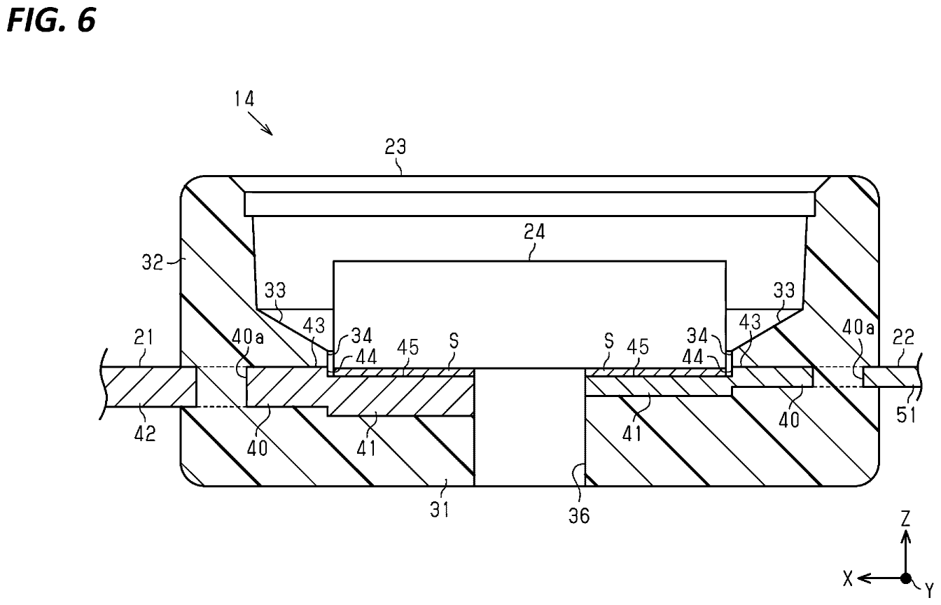

The embodiment given above can be modified and carried out as follows. The embodiment given above and variations described below can be combined and carried out as appropriate unless they are technically contradictory to each other.
As shown in FIG. 6, in the resin molded portion 23, the recess portion 36 may be a hole that extends through the bottom wall 31 in the height direction Z. With this configuration, whether a solder bridge has been formed between the conductive members 21 and 22 can be checked from the lower side of the resin molded portion 23 through the recess portion 36 that is a through hole. In the case where the resin molded portion 23 is configured to be waterproof, it is necessary to seal the recess portion 36 that is a through hole using, for example, a potting material or the like. In this respect, by configuring the recess portion 36 to not extend through the bottom wall 31 as in the embodiment given above, the waterproof properties of the recess portion 36 can be ensured without using a potting material.
In the resin molded portion 23 of the embodiment given above, the recess portion 36 may be omitted.
In the embodiment given above, the positioning surface 34 of the resin molded portion 23 is formed above the stepped surface 44 of the conductive member 21 or 22. However, the configuration is not particularly limited thereto. The positioning surface 34 may be formed above the first surface 43 of the conductive member 21 or 22. In this case, the stepped surface 44 and a portion of the first surface 43 are included in the first protruding portion 41, or in other words, the stepped surface 44 and a portion of the first surface 43 are located on the inner circumferential side of the surrounding wall 32 of the resin molded portion 23. With this configuration as well, due to the stepped surface 44, burrs of the resin molded portion 23 in a portion that is in contact with the first surface 43 are unlikely to reach the second surface 45, and it is therefore possible to make it unlikely for the burrs to be formed on the second surface 45.
In the resin molded portion 23 of the embodiment given above, the positioning surface 34 may be omitted.
In the conductive member 21 or 22 of the embodiment given above, the stepped surface 44 is formed through half-blanking processing. However, the processing for forming the stepped surface 44 is not limited thereto.
In the conductive member 21 or 22 of the embodiment given above, a portion that corresponds to the stepped surface 44 may have a flat lower surface. That is, the stepped surface 44 may be formed by simply displacing the upper surface of the conductive members 21 and 22.
The configuration, such as thickness, of the conductive member 21 or 22 is not limited to that of the embodiment given above, and can be changed as appropriate.
The shape of the bent portion 53 of the second protruding portion 51 is not limited to that of the embodiment given above, and can be changed as appropriate according to the configuration. Also, in the second conductive member 22 of the embodiment given above, the bent portion 53 may be omitted.
In the second conductive member 22 of the embodiment given above, the crimped portion 52 may be omitted, and the second conductive member 22 may be connected to the electric wire 15 through welding or the like.
In the terminal 14 of the embodiment given above, the first conductive member 21 may be connected to a member other than the bus bar 13.
In the terminal 14 of the embodiment given above, the second conductive member 22 may be connected to a member other than the electric wire 15.
The terminal 14 of the embodiment given above includes two conductive members 21 and 22, but the configuration is not limited thereto. The terminal 14 may be configured to include only one conductive member.
In the embodiment given above, the terminal 14 for use in the battery wiring module 10 is used. However, the terminal 14 is not limited thereto, and a terminal for use in a device other than the battery wiring module 10 may also be used.
The embodiment disclosed herein is exemplary in all aspects. Accordingly, the invention of the present application should not be limited to the examples given above. That is, the scope of the invention of the present application is indicated by the appended claims, and all changes that come within the meaning and range of equivalency of the claims are intended to be embraced within the scope of the invention of the present application.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A terminal comprising:
a resin molded portion;
a plate-shaped conductive member which is partially embedded in the resin molded portion; and
an electronic component that is connected to the conductive member,
wherein an upper surface of the conductive member includes: a first surface that is in contact with the resin molded portion; a stepped surface that extends downward from the first surface; and a second surface that is connected to the first surface via the stepped surface and located at a position lower than the first surface,
the second surface is entirely located outside of the resin molded portion, and
the electronic component is connected to the second surface.

2. The terminal according to claim 1,
wherein the resin molded portion includes a positioning surface configured to allow the electronic component to be positioned, and
the conductive member includes: an embedded portion that includes the first surface as an upper surface thereof and is embedded in the resin molded portion; and a first protruding portion that includes the second surface as an upper surface thereof and protrudes outside of the resin molded portion from the positioning surface.

3. The terminal according to claim 2,
wherein the positioning surface is formed above the stepped surface.

4. The terminal according to claim 2,
wherein the conductive member further includes a second protruding portion that protrudes outward from the resin molded portion, and
the second protruding portion includes: a crimped portion to which an electric wire is crimped; and a bent portion that is provided between a root portion of the second protruding portion and the crimped portion.

5. The terminal according to claim 1,
wherein the terminal includes two conductive members, each of which is configured as defined in claim 1, and
the two conductive members are electrically connected to each other via the electronic component.

6. The terminal according to claim 5,
wherein the resin molded portion includes: a bottom wall that covers an underside of the two conductive members; and a surrounding wall that extends upward from the bottom wall and surrounds the electronic component,
the bottom wall includes a recess portion that is recessed downward at a position between the second surfaces of the two conductive members, and
the electronic component is connected to the second surfaces of the two conductive members through soldering.

7. A battery wiring module comprising:
the terminal according to claim 1.
